(19) United States
(12) Patent Application Publication
(10) Pub. No.: US 2015/0159873 A1
(43) Pub. Date: Jun. 11, 2015

(54) COMPRESSOR DISCHARGE CASING ASSEMBLY

(71) Applicant: General Electric Company, Schenectady, NY (US)

(72) Inventors: Patrick Benedict Melton, Horse Shoe, NC (US); Richard Martin DiCintio, Simpsonville, SC (US)

(73) Assignee: General Electric Company, Schenectady, NY (US)

(21) Appl. No.: 14/101,888

(22) Filed: Dec. 10, 2013

(51) Int. Cl. F23R 3/10; F01D 25/26; F02C 3/14

(52) U.S. Cl. CPC F23R 3/10; F02C 3/14; F01D 25/26; F05D 2210/12; F05D 2220/32; F05D 2240/35; F05D 2240/90

(57) ABSTRACT

A compressor discharge casing assembly includes a diffuser disposed proximate an aft region of a compressor section, the diffuser configured to route a compressed airflow to an interior region of the compressor discharge casing assembly. Also included is a strut disposed in the interior region of the compressor discharge casing assembly and located proximate an exit region of the diffuser. Further included is a heat shield disposed proximate an upstream portion of the strut, the heat shield configured to reduce impingement of the compressed airflow on the strut.

### BACKGROUND OF THE INVENTION

The subject matter disclosed herein relates to turbine assemblies and, more particularly, a compressor discharge casing assembly.

A combustor assembly of a gas turbine engine is configured to receive a compressed, highly pressurized airflow from a compressor for mixing with a fuel for combustion purposes. Routing of the compressed airflow to the combustor is facilitated, in part, by providing the compressed airflow to an interior region of a compressor discharge casing (CDC) that partially surrounds a combustor can.

The CDC includes at least one strut that is operatively coupled to an inner support ring of a turbine shell. The inner support ring supports one end of a stage one nozzle that is located proximate an inlet of a turbine section of the gas turbine engine. The other end of the stage one nozzle is supported by an outer support ring. The strut is located proximate an exit of the compressor, such that heated air directly impinges upon the upstream portion of the strut, thereby causing the strut to heat up relatively rapidly during startup, and cool down relatively rapidly during shutdown. The rapid heating of the strut results in thermal growth of the strut that pushes on the inner support ring that is coupled to the stage one nozzle. Such a force on the stage one nozzle results in large transient motion between a transition piece and the stage one nozzle, thereby requiring more air to be used for cooling and purge of these regions. The additional air used for cooling and purge directly impacts the overall efficiency of the gas turbine engine, as any air that is diverted from combustion purposes is recognized as a system loss.

### BRIEF DESCRIPTION OF THE INVENTION

According to one aspect of the invention, a compressor discharge casing assembly includes a diffuser disposed proximate an aft region of a compressor section, the diffuser configured to route a compressed airflow to an interior region of the compressor discharge casing assembly. Also included is a strut disposed in the interior region of the compressor discharge casing assembly and located proximate an exit region of the diffuser. Further included is a heat shield disposed proximate an upstream portion of the strut, the heat shield configured to reduce impingement of the compressed airflow on the strut.

According to another aspect of the invention, a combustor assembly includes a combustor for producing a hot gas flow. Also included is a transition piece configured to route the hot gas flow to an inlet of a turbine section. Further included is a compressor discharge casing assembly surrounding a portion of the combustor assembly and configured to receive a compressed airflow to be used for combustion in the combustor. Yet further included is a diffuser configured to route the compressed airflow from a compressor section to an interior region of the compressor discharge casing assembly. Also included is a strut disposed proximate an exit region of the diffuser. Further included is a heat shield disposed proximate an upstream portion of the strut, the heat shield configured to reduce impingement of the compressed airflow on the strut.

According to yet another aspect of the invention, a gas turbine engine includes a compressor section, a combustor section, a turbine section, and a compressor discharge casing assembly. The compressor discharge casing assembly includes a diffuser configured to route a compressed airflow from the compressor section to an interior region of the compressor discharge casing assembly. The compressor discharge casing assembly also includes a strut disposed proximate an exit region of the diffuser, the strut operatively coupled to, and extending between, a compressor discharge casing bulkhead and an inner support ring of a turbine shell of the turbine section. The compressor discharge casing assembly further includes a heat shield disposed proximate an upstream portion of the strut, the heat shield configured to reduce impingement of the compressed airflow on the strut.

These and other advantages and features will become more apparent from the following description taken in conjunction with the drawings.

### BRIEF DESCRIPTION OF THE DRAWINGS

The subject matter, which is regarded as the invention, is particularly pointed out and distinctly claimed in the claims at the conclusion of the specification. The foregoing and other features, and advantages of the invention are apparent from the following detailed description taken in conjunction with the accompanying drawings in which:

FIG. 1 is a schematic illustration of a gas turbine engine;

FIG. 2 is a cross-sectional schematic illustration of a combustion section of the gas turbine engine, the combustion section including a compressor discharge casing assembly associated therewith;

FIG. 3 is a side view of a strut of the compressor discharge casing assembly; and

FIG. 4 is a schematic illustration of a heat shield disposed along an upstream portion of the strut of the compressor discharge casing.

The detailed description explains embodiments of the invention, together with advantages and features, by way of example with reference to the drawings.

### DETAILED DESCRIPTION OF THE INVENTION

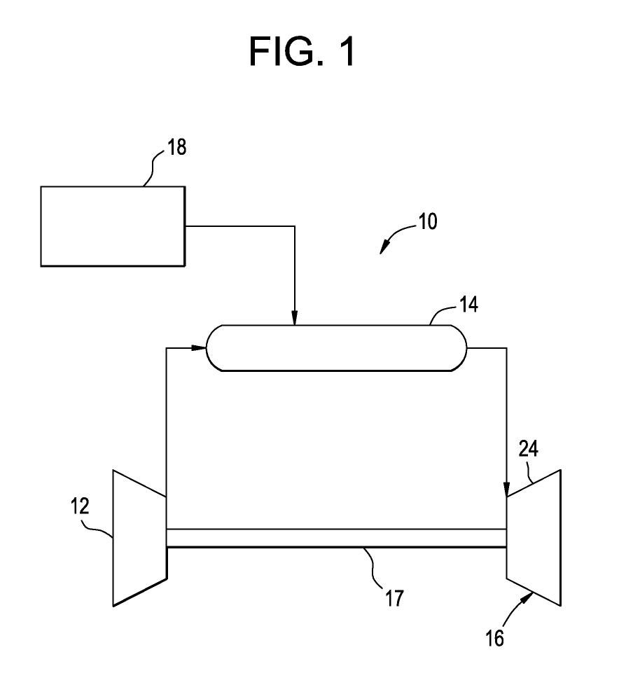

Referring to FIG. 1, a turbine system, such as a gas turbine engine, for example, is schematically illustrated with reference numeral 10. The gas turbine engine 10 includes a compressor section 12, a combustor section 14, a turbine section 16, a rotor 17 and a fuel nozzle 18. It is to be appreciated that one embodiment of the gas turbine engine 10 may include a plurality of compressors 12, combustors 14, turbines 16, rotors 17 and fuel nozzles 18. The compressor section 12 and the turbine section 16 are coupled by the rotor 17.

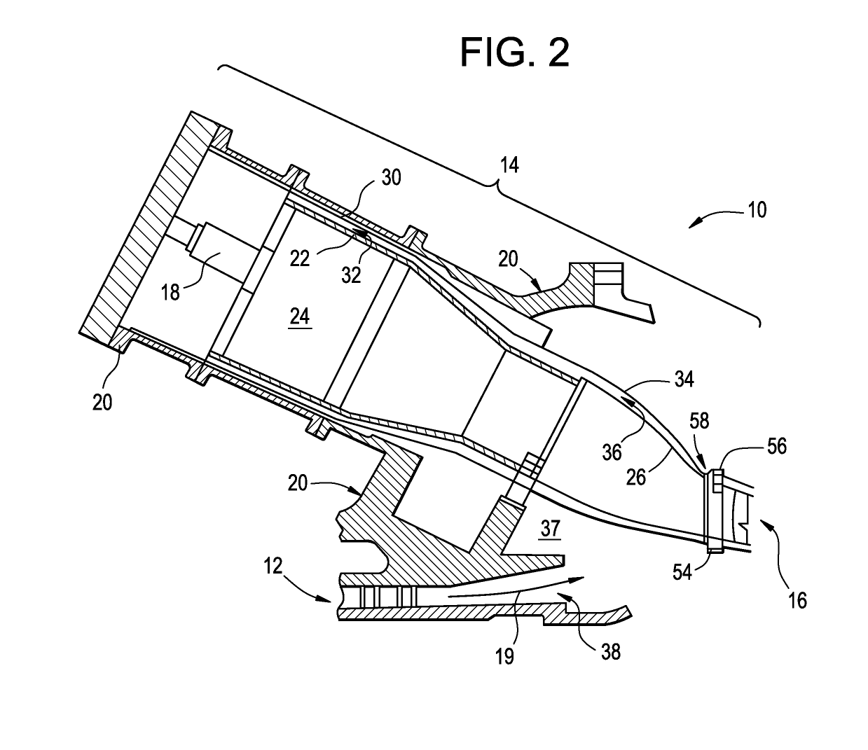

Referring to FIG. 2, a simplified drawing of several portions of the gas turbine engine 10 is illustrated. The gas turbine engine 10 comprises the compressor section 12 for pressurizing a working fluid, referred to as a compressed airflow 19 that is flowing through the gas turbine engine 10. The compressed airflow 19 discharged from the compressor section 12 flows into the combustor section 14, which is generally characterized by a plurality of combustors (only one of which is illustrated in FIGS. 1 and 2) disposed in an annular array about an axis of the gas turbine engine 10. The compressed airflow 19 entering the combustor section 14 is mixed with fuel, such as natural gas or another suitable liquid or gas, and combusted. Hot gases of combustion flow from each combustor to the turbine section 16 to drive the gas turbine engine 10 and generate power.

Each combustor in the gas turbine engine 10 may include a variety of components for mixing and combusting the compressed airflow 19 and fuel. For example, the combustor may include a casing, such as a compressor discharge casing (CDC) 20. A variety of sleeves, which may be generally annular sleeves, may be at least partially disposed in the CDC 20. For example, a combustor liner 22 may generally define a combustion zone 24 therein. Combustion of the compressed airflow 19, fuel, and optional oxidizer may generally occur in the combustion zone 24. The resulting hot gases of combustion may flow downstream through the combustor liner 22 into a transition piece 26. A flow sleeve 30 may generally surround at least a portion of the combustor liner 22 and define a flow path 32 therebetween. An impingement sleeve 34 may generally surround at least a portion of the transition piece 26 and define a flow path 36 therebetween. Alternatively, a single liner and a single sleeve may form a single flow path. The compressed airflow 19 entering the combustor section 14 may flow into an interior region 37 of the CDC 20 through an external annulus 38 defined by the CDC 20 and at least partially surrounding the various sleeves. At least a portion of the compressed airflow 19 may enter the flow paths 32 and 36 through holes (not shown) defined in the flow sleeve 30 and the impingement sleeve 34. As discussed below, the working fluid may then enter the combustion zone 24 for combustion.

It should be readily appreciated that a combustor need not be configured as described above and illustrated herein and may generally have any configuration that permits working fluid to be mixed with fuel, combusted and transferred to a turbine section 16 of the gas turbine engine 10. For example, the present disclosure encompasses annular combustors and silo-type combustors as well as any other suitable combustors.

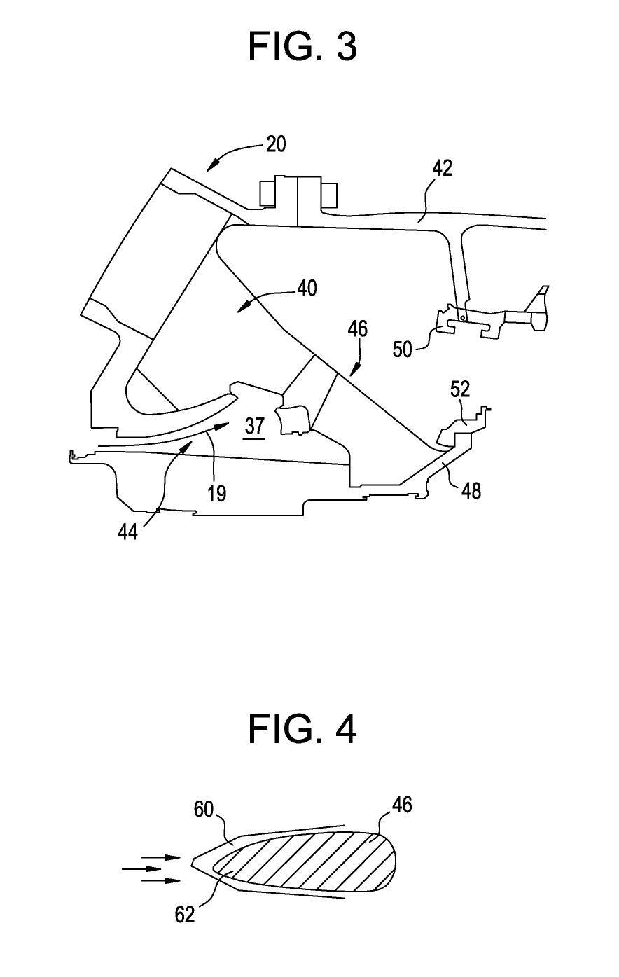

Referring now to FIG. 3, the CDC 20 is schematically illustrated in greater detail, with the combustor removed for illustration purposes to enhance the view of various portions of the CDC 20. The CDC 20 includes a CDC bulkhead 40 that is operatively coupled to an outer turbine shell 42 proximate a radially outer region of the CDC 20. The aft region of the compressor section 12 may be characterized as a diffuser 44 that discharges the compressed airflow 19 into the interior region 37 of the CDC 20. The CDC 20 also includes a strut 46 that is located proximate the exit region of the diffuser 44. The strut 46 is operatively coupled to, and extends between, the CDC bulkhead 40 and an inner turbine shell 48. The outer turbine shell 42 includes, or is operatively coupled to, an outer support ring 50, while the inner turbine shell 48 includes, or is operatively coupled to, an inner support ring 52. The outer support ring 50 and the inner support ring 52 support an outer end 54 and an inner end 56, respectively, of a stage one nozzle 58 (FIG. 2) located at the inlet of the turbine section 16.

As shown the strut 46 is located in a region that is subject to impingement of the high temperature air that exits the compressor section 12 as the compressed airflow 19. In order to avoid rapid heating of the strut 46 during start-up of the gas turbine engine 10, for example, a heat shield 60 is included and located along an upstream portion 62 of the strut 46. The heat shield 60 may be formed of any material suitable to withstand the operating temperatures present in the interior region 37 of the CDC 20. In one embodiment, the heat shield 60 is operatively coupled to the strut 46. In another embodiment, the heat shield 60 is operatively coupled solely to the inner turbine shell 48 or to the inner turbine shell 48 and the strut 46. Alternatively, the heat shield 60 may be operatively coupled to another component of the CDC 20 and/or the diffuser 44. Regardless of which component(s) the heat shield 60 is coupled to, the heat shield 60 is spaced from the upstream portion 62 of the strut 46. The heat shield 60 extends along an entire length of, or a portion of, the upstream portion 62 of the strut 46 to reduce the rate of heat transfer that the strut 46 experiences. In one embodiment, the heat shield 60 extends along the strut 46 in the longest dimension of the strut 46 (i.e., along an entire length of the strut 46). In another embodiment, the heat shield 60 extends only along a portion of the strut 46 that is directly exposed to impingement of the high temperature air that exits the compressor section 12.

By reducing the heat transfer rate on the strut 46, less rapid thermal growth of the strut 46 is achieved. The resulting heat transfer reduction advantageously facilitates a more balanced heat transfer rate, and therefore more uniform thermal growth rate, of all components of the CDC 20. A more uniform growth rate reduces transient motions and relative motion between associated components. For example, by reducing the thermal growth rate of the strut 46, the force exerted by the strut 46 on the inner support ring 52 is increased at a lower rate than would otherwise be observed without the heat shield 60, thereby reducing relative motion between the transition piece 26 and the stage one nozzle 58.

While the invention has been described in detail in connection with only a limited number of embodiments, it should be readily understood that the invention is not limited to such disclosed embodiments. Rather, the invention can be modified to incorporate any number of variations, alterations, substitutions or equivalent arrangements not heretofore described, but which are commensurate with the spirit and scope of the invention. Additionally, while various embodiments of the invention have been described, it is to be understood that aspects of the invention may include only some of the described embodiments. Accordingly, the invention is not to be seen as limited by the foregoing description, but is only limited by the scope of the appended claims.

1. A compressor discharge casing assembly comprising:
a diffuser disposed proximate an aft region of a compressor section, the diffuser configured to route a compressed airflow to an interior region of the compressor discharge casing assembly;
a strut disposed in the interior region of the compressor discharge casing assembly and located proximate an exit region of the diffuser; and
a heat shield disposed proximate an upstream portion of the strut, the heat shield configured to reduce impingement of the compressed airflow on the strut.

2. The compressor discharge casing assembly of claim 1, wherein the strut is operatively coupled to, and extends between, a compressor discharge casing bulkhead and an inner support ring.

3. The compressor discharge casing assembly of claim 1, wherein the heat shield is operatively coupled to the strut.

4. The compressor discharge casing assembly of claim 2, further comprising a nozzle disposed proximate an inlet of a turbine section, the nozzle operatively coupled to the inner support ring and an outer support ring.

5. The compressor discharge casing assembly of claim 4, wherein the heat shield is configured to reduce a rate of thermal growth of the strut.

6. The compressor discharge casing assembly of claim 4, wherein the heat shield is configured to reduce relative motion between a transition piece and the nozzle.

7. The compressor discharge casing assembly of claim 1, wherein the heat shield extends along the strut for an entire length of the strut.

8. The compressor discharge casing assembly of claim 2, wherein the heat shield is operatively coupled to the inner support ring.

9. A combustor assembly comprising:
a combustor for producing a hot gas flow;
a transition piece configured to route the hot gas flow to an inlet of a turbine section;
a compressor discharge casing assembly surrounding a portion of the combustor assembly and configured to receive a compressed airflow to be used for combustion in the combustor;
a diffuser configured to route the compressed airflow from a compressor section to an interior region of the compressor discharge casing assembly;
a strut disposed proximate an exit region of the diffuser; and
a heat shield disposed proximate an upstream portion of the strut, the heat shield configured to reduce impingement of the compressed airflow on the strut.

10. The combustor assembly of claim 9, wherein the strut is operatively coupled to, and extends between, a compressor discharge casing bulkhead and an inner support ring.

11. The combustor assembly of claim 9, wherein the heat shield is operatively coupled to the strut.

12. The combustor assembly of claim 10, further comprising a nozzle disposed proximate the inlet of the turbine section, the nozzle operatively coupled to the inner support ring and an outer support ring.

13. The combustor assembly of claim 12, wherein the heat shield is configured to reduce a rate of thermal growth of the strut.

14. The combustor assembly of claim 12, wherein the heat shield is configured to reduce relative motion between the transition piece and the nozzle.

15. The combustor assembly of claim 9, wherein the heat shield extends along the strut for an entire length of the strut.

16. The combustor assembly of claim 10, wherein the heat shield is operatively coupled to the inner support ring.

17. A gas turbine engine comprising:
a compressor section;
a combustor section;
a turbine section; and
a compressor discharge casing assembly comprising:
a diffuser configured to route a compressed airflow from the compressor section to an interior region of the compressor discharge casing assembly;
a strut disposed proximate an exit region of the diffuser, the strut operatively coupled to, and extending between, a compressor discharge casing bulkhead and an inner support ring of a turbine shell of the turbine section; and
a heat shield disposed proximate an upstream portion of the strut, the heat shield configured to reduce impingement of the compressed airflow on the strut.

18. The gas turbine engine of claim 17, wherein the heat shield is operatively coupled to the strut.

19. The gas turbine engine of claim 17, further comprising a nozzle disposed proximate an inlet of the turbine section, the nozzle operatively coupled to the inner support ring and an outer support ring, wherein the heat shield is configured to reduce a rate of thermal growth of the strut and relative motion between a transition piece and the nozzle.

20. The gas turbine engine of claim 17, wherein the heat shield extends along the strut for an entire length of the strut.
